(19) United States
(12) Patent Application Publication
(10) Pub. No.: US 2004/0111902 A1
(43) Pub. Date: Jun. 17, 2004

(54) Plumber's spotting tool

(76) Inventor: Terry Fletcher, Fresno, CA (US)

Correspondence Address: MARK D MILLER, KIMBLE, MACMICHAEL & UPTON, 5260 NORTH PALM AVENUE, SUITE 221, FRESNO, CA, 93704, US

(21) Appl. No.: 10/322,028

(22) Filed: Dec. 16, 2002

(51) Int. Cl. G01C 15/00

(52) U.S. Cl. 33/286

(57) ABSTRACT

A pipe alignment device utilizing a light source to project a spot onto the opposite structure for use in spotting the locations of roof openings for plumbing ventilation pipes in new building construction. The device is in the form of a cylindrical housing having several different stepped diameters for insertion into top plate holes of different sizes. The different diameters are sized in accordance with various standard sized pipes and fittings. The light source may be integrated or insertable, and battery-operated or externally powered. One or more levels may also be included in the device to assist in the alignment process.

### BACKGROUND OF THE INVENTION

1. Field of the Invention

The present invention relates to ventilation pipe installation in new construction, and more particularly to a spotting tool for precisely identifying the locations where ventilation pipe openings are to be cut into the roof of a new building.

2. Description of the Prior Art

It is well known that ventilation pipes are required in building plumbing systems in order for the pipe systems to operate properly. In new construction, the plumbing systems for the building are generally installed in the initial phases, usually at or near the time when the basic framing of the structure is being erected. Plumbing pipes are generally installed within these frames so as to be located behind the walls of the completed structure. Typically, plumbing ventilation pipes extend upward from these frames, through the attic area, and through openings in the roof to the outside. More specifically, these ventilation pipes must be run upward through holes in the top plates of the frame members within the structure to and through the sheeting material of the attic to the roof area above. The hole in the top plate should be properly aligned with the hole in the roof so that the pipe is installed as straight as possible.

The traditional procedure for aligning such pipes requires that the tradesperson first drill a hole in the top plate, then climb a ladder to the attic or roof area to use a plumb bob placed over the center of the top plate hole to mark the corresponding attic or roof location. The tradesperson must then climb down the ladder to obtain a drill, climb back up the ladder to drill the hole for the pipe, and then finally insert the pipe through the two holes. This procedure may require two tradespersons as well as numerous trips up and down the ladder, often while the tradesperson is carrying various pieces of equipment, before he or she is able to obtain an accurate plumb line. Attic or roof areas for single floor residential structures are generally at least twelve to fifteen feet above the ground level, if not more, such that additional trips up and down the ladder substantially increase the risk that the tradesperson will fall and be injured. Multi-story buildings further increase this risk.

A variety of devices have been developed for spotting locations on ceilings or other overhead locations, many of which project visible laser beams onto the target surfaces. For example, U.S. Pat. No. 5,784,793 discloses a device having a template and laser beam unit. The template is used to indicate the spot on the base surface, while the laser beam unit is then placed over the template to indicate the corresponding spot upon the opposite surface. U.S. Pat. No. 5,144,487 discloses a laser alignment tool which simultaneously indicates level, plumb and square alignment. This is accomplished by an optical assembly within the device housing which generates multiple and simultaneous laser beams. Other inventions further compensate for tilted base surfaces. For example, U.S. Pat. Nos. 4,852,265, 5,075,977 and 5,459,932 all disclose devices which utilize laser beams to project straight lines in true horizontal or vertical orientations regardless of tilt in the base surface. These devices generally utilize movably suspended platforms, gravitational forces, and one or more mirrors or lenses for tilt compensation.

Unfortunately, none of the above-described devices are suitable for use in spotting the positions of plumbing ventilation pipes in new construction. This is because these devices are generally designed for use where there is a large, flat surface available such as a floor. It would be cumbersome and difficult, if not impossible to use these devices on the top plate of a framing structure where a pipe opening has been cut. Many of the devices are simply too large for such use, and the others are incapable of compensating for the uneven surface of the top plate where the hole has been cut. Most of the above inventions require relatively complex and expensive optical systems. They involve careful manufacture, assembly, transportation, use and maintenance so as not to damage the sensitive components within. Furthermore, those devices must be aligned by sight, possibly increasing the margin of error.

It is therefore desirable to provide a tool for use in spotting the locations of roof openings for plumbing ventilation pipes in new building construction.

### SUMMARY OF THE INVENTION

The present invention provides a simple, durable and easily used tool for use in spotting the locations of roof openings for plumbing ventilation pipes in new building construction. The tool of the present invention is in the form of a cylindrical housing having several different stepped diameters for insertion into top plate holes of different sizes. The tool is designed such that the several diameters incrementally decrease in size from a large central “stop,” to more and more narrow diameters at the ends of the tool. The different diameters are sized in accordance with various standard sized pipes and fittings. The stepped diameters are equal to or slightly larger than these standard sizes since the hole that is cut in the top plate of the building frame will also be slightly larger than the pipe that is to pass through it. A wide ring or “stop” is provided at the center of the tool to prevent it from passing through very large openings.

A light source is also provided with the housing of the present invention. This light source may be integrated into the housing, or may be in removable insertable form such as a battery operated flashlight or laser pointer, or an externally powered lamp. When installed and activated, the light source faces upward from the housing and projects a spot onto the inside surface of the roof above the hole in the top plate, indicating the location on this surface where the external vent hole should be drilled.

In one aspect of the invention, one or more levels are built into the housing, permitting the tradesperson to verify that the invention is properly inserted into the top plate hole for proper vertical alignment, and to confirm that the top plate hole itself was drilled upon a level surface.

Accordingly, the present invention provides the tradesperson with a simple, inexpensive and rugged device for spotting the location for roof openings for ventilation pipes, without requiring multiple trips up and down a ladder, or the use of a plumb bob. The invention does not involve sensitive or fragile components, but consists of very few, generally immovable and uncomplicated parts. It allows the tradesperson to simply insert the invention into any drilled hole to immediately ascertain the location of a corresponding spot on the opposite surface.

It is therefore a primary object of the present invention to provide a simple, durable and easily used apparatus for spotting the location for a plumbing ventilation pipe opening on an overhead surface.

It is also a primary object of the present invention to improve safety and increase efficiency in the installation of plumbing ventilation pipes in new construction by providing a tool for spotting the locations of overhead ventilation pipe openings that avoids multiple trips up and down a ladder to identify and cut such openings.

It is also an important object of the present invention to provide a cylindrical tool having multiple stepped diameters for insertion into pipe openings of different sizes that have been cut into the top plates of framing structures of a building, the tool having a light source for projecting a spot onto the overhead surface above the given pipe opening.

It is also an important object of the present invention to provide a cylindrical spotting tool having a detachable light source for projecting a spot onto an overhead surface above a pipe opening in the top plate of a building frame.

It is also an important object of the present invention to provide a cylindrical spotting tool having an integrated light source for projecting a spot onto an overhead surface above a pipe opening in the top plate of a building frame.

It is also an important object of the present invention to provide a cylindrical spotting tool having a light source for projecting a spot onto an overhead surface above a pipe opening in the top plate of a building frame and one or more levels for horizontal and vertical alignment of the tool.

It is another object of the present invention to provide a spotting tool that is simple and inexpensive to manufacture, assemble, utilize and maintain.

It is another object of the present invention to provide a spotting tool that allows for quick and accurate alignment of the drilled holes, with a minimal margin of error and a minimal number of intermediary steps.

It is another object of the present invention to provide a spotting tool that for projecting a spot onto an overhead surface above a pipe opening in the top plate of a building frame without the necessity of a solid and intact surface.

Additional objects of the invention will be apparent from the detailed descriptions and the claims herein.

### BRIEF DESCRIPTION OF THE DRAWINGS

FIG. 1 is an environmental perspective view of the present invention, showing the invention inserted into a hole in the top plate of a frame structure, and projecting a spot of light onto the lower surface of the roof above.

FIG. 2 is a cross sectional side view along line 2--2 of FIG. 1.

FIG. 3 is a front perspective view of a first embodiment of the invention showing an exemplary removable and externally powered light source.

FIG. 4 is a front perspective view of a second embodiment of the invention illustrating an exemplary integrated self-contained light source.

FIG. 5 is a front perspective view of a third embodiment of the invention including a level.

### DETAILED DESCRIPTION OF A PREFERRED EMBODIMENT

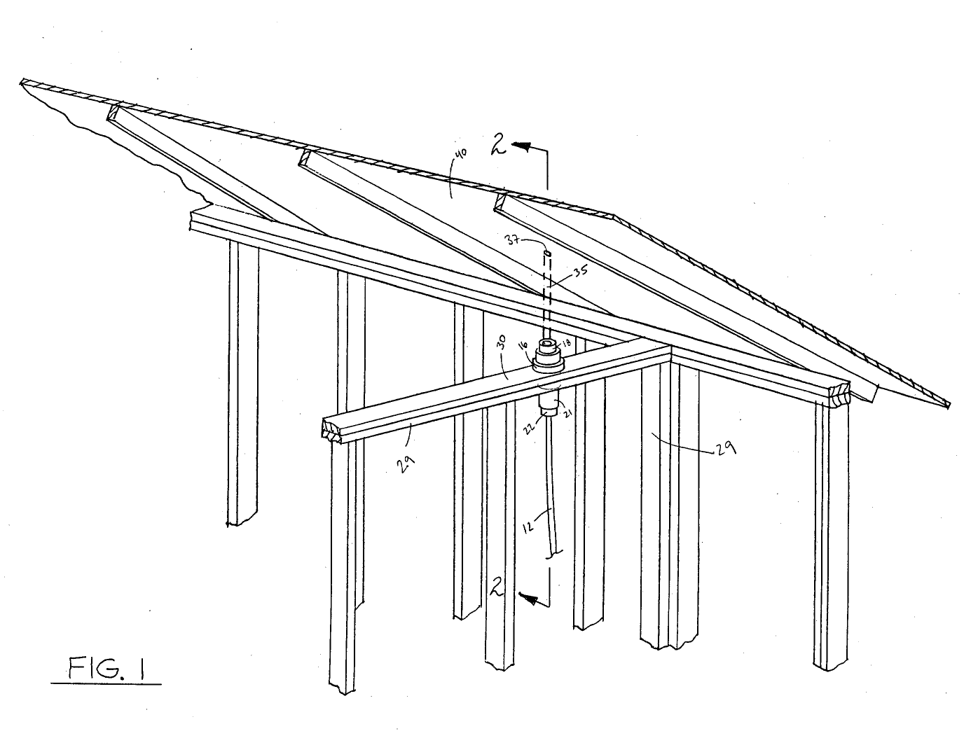

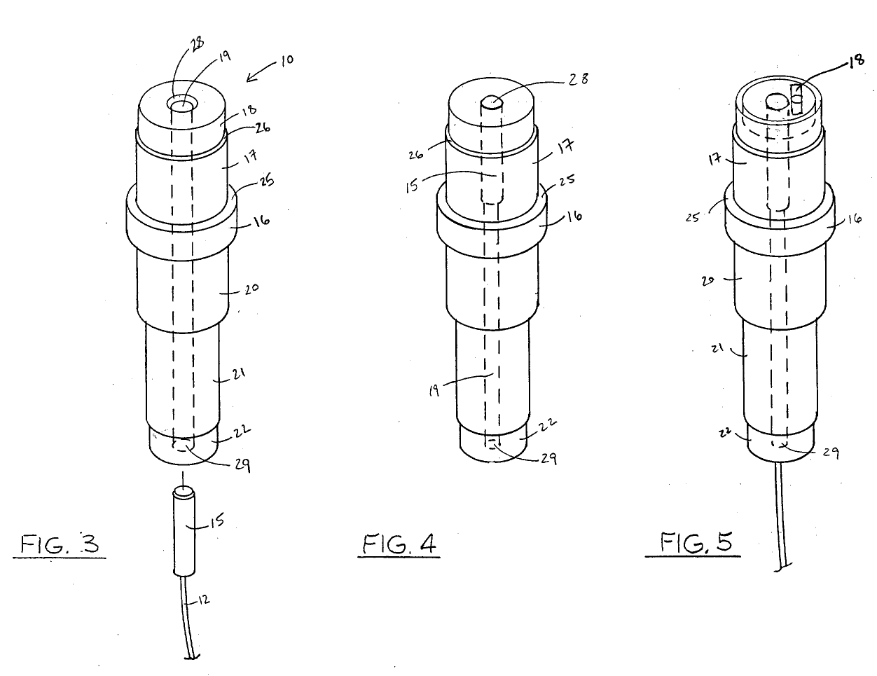

Referring to the drawings wherein like reference characters refer to the same or corresponding structures throughout the several views, and referring specifically to FIGS. 3-5 it is seen that the invention includes a cylindrical housing generally 10 made up of a plurality of cylindrical segments of different diameters. A large diameter stop ring or coupling 16 is provided near the center of housing 10. Stop ring 16 protrudes out to prevent the housing 10 from slipping down into a drilled hole 31 as shown in FIG. 1. One or more cylindrical segments 17, 18 are provided at one end of housing 10 upstream from stop ring 16. Similarly, one or more additional cylindrical segments 20, 21, 22 are provided at the opposite end of housing 10, downstream from stop ring 16. Each cylindrical segment has a different diameter, and is separated from adjacent segments by an annular shoulder such as 25, 26. While a total of five segments are shown in the exemplary illustrations, it is to be appreciated that any number of such segments may be provided either upstream or downstream from the stop ring 16.

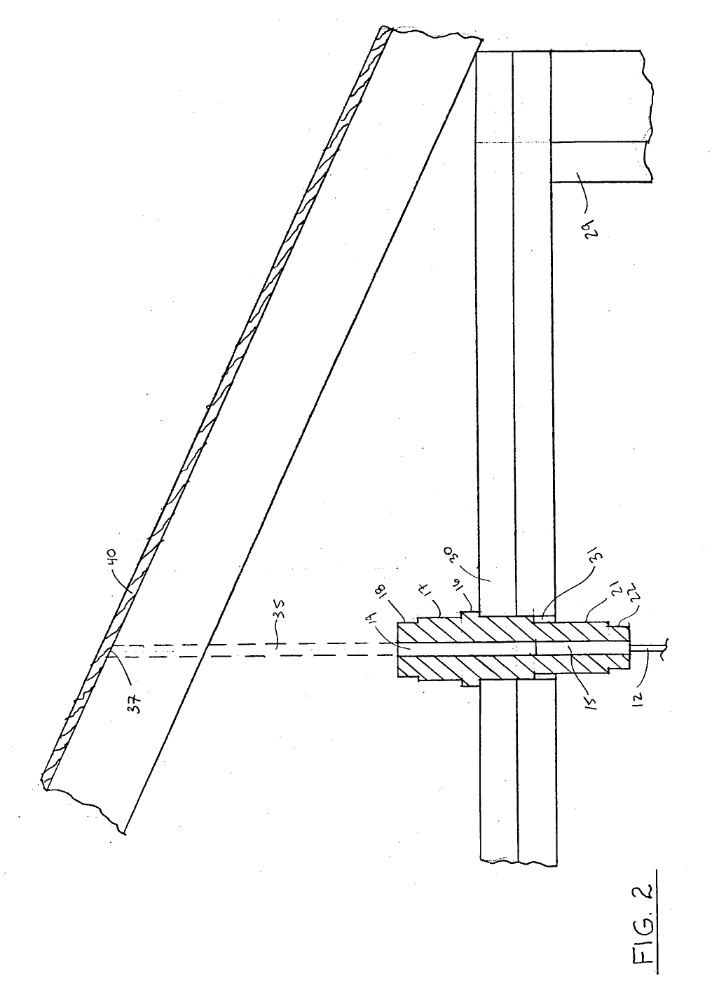

Referring to FIGS. 1 and 2, it is seen that housing 10 is designed to be inserted into a circular opening 31 that has been drilled or cut into the top plate 30 of an internal frame structure 29 of a building.

The outer diameters of the cylindrical segments (17, 18, 20, 21, 22) of housing 10 are established according to standard sizes for pipes and fittings. In the preferred embodiment, these diameters are exactly the same as the outer diameters for the corresponding pipes or fittings. In other embodiments, the outer diameters of the segments may be slightly larger or slightly smaller than these standard sizes. Larger diameter segments may be used in order to fit more snugly into the circular openings 31 for the pipes, since these openings are generally slightly larger in diameter than the pipes themselves. FIGS. 1 and 2 show the invention resting snugly in opening 31. Stop ring 16 is designed to be larger in diameter than any potential opening 31, thereby preventing the housing 10 from falling through opening 31.

It is to be appreciated that the invention may be provided in a variety of different sizes, and that different combinations of cylindrical segments having different diameters may be provided. By way of example and for illustrative purposes only, and without limiting the appended claims, a first exemplary embodiment of the invention may be provided for use in residential home construction. In such an embodiment, segment 22 may have a diameter of 1½ inches which is the same as a standard pipe diameter; segment 21 may have a diameter of 2 inches which is the same as another standard pipe diameter; and segment 20 may have a diameter of 2½ inches for the same reason. In this example, stop ring 16 is given a diameter of 3¼ inches because no pipe is specified in the residential construction having a diameter in excess of 3 inches. On the opposite side of stop ring 16, segment 17 may have an intermediate diameter of 1¾ inches corresponding to a lesser used standard pipe diameter, and segment 18 may have a diameter of 2¼ inches for the same reason.

In a second exemplary embodiment, again provided for illustrative purposes only, segment 22 may have a diameter of 1 9/16 inches, which is slightly larger than the standard pipe diameter of 1½ inches; segment 21 may have a diameter of 2 1/16 inches, which is slightly larger than the standard pipe diameter of 2 inches; and segment 20 may have a diameter of 2 9/16 inches, which is slightly larger than the standard pipe diameter of 1½ inches. Each of these diameters is selected because openings 31 are expected to be slightly larger in diameter than the standard-size pipe that will pass through them, such that the segments will more snugly fit into openings 31. As with the previous exemplary embodiment, stop ring 16 is given a diameter greater than 3 inches because no pipe is specified in the residential construction having a diameter in excess of 3 inches. Then, on the opposite side of stop ring 16, segment 17 may have an intermediate diameter of 1 13/16 inches, which is slightly larger than a the standard pipe diameter of 1¾ inches, and segment 18 may have a diameter of 2 5/16 inches, which is slightly larger than a the standard pipe diameter of 2¼ inches.

In a third exemplary embodiment for use in a commercial building, again provided for illustrative purposes only, the specifications may call for pipe diameters ranging from as small as two inches to as large as ten inches. In such a case, the segments would be sized to correspond to these dimensions, with stop ring 16 sized larger than the largest diameter pipe (i.e., larger than ten inches).

In other alternative embodiments, the differences between the diameters of the segments may be evenly spaced in increments of one-eighth inch, one-quarter inch, one-half inch, one-inch and so on. Alternatively, the diameters of the segments may not be evenly spaced, but may instead be selected from a group of the most commonly used pipe sizes. Other embodiments may use metric or other units of measurement.

A longitudinal axial bore 19 is provided in the center of housing 10. Bore 19 may extend the length of housing 10 having an first opening 28 at one end of housing 10, and a second opening 29 at the opposite end. Alternatively, bore 19 may be broken into two segments, each of which extend only partway through housing 10, such that openings 28 and 29 are not in communication with each other. A removable or permanent light source 15 is deployed in bore 19 such that it sends a beam of light out through one of openings 28 or 29. A removable light source 15 is shown in FIG. 3. In this illustration, a cylindrical lamp 15 with power supplied through wire 12 from an exterior power source is provided for removable installation into bore 19. It is to be appreciated that self-contained (e.g. battery operated) lighting sources 15 such as a flashlight or laser pointer may be alternatively be used for removable insertion into bore 19. Bore 19 may have any suitable diameter in order to receive the removable light source (e.g. the body of a flashlight or laser pointer).

Once housing 10 is inserted into opening 31 as shown in FIG. 1, the light source 15 activated. This sends a beam of light 35 upward making a spot 37 on the opposite surface 40 (i.e., the underside of the roof) above. This spot 37 marks the location for drilling or cutting an opening to the outside.

The embodiment of FIG. 4 illustrates the housing 10 of the present invention with a self-contained integrated light source 15 such as a flashlight or laser pointer. The embodiment of FIG. 5 shows a similar light source requiring external power. One or more levels 18 may be provided on or in housing 10, such as the one shown in FIG. 5, to help position the housing to assure that the internal bore 19 is in a vertical position before any hole is cut in the roof Levels 18 may also be used to confirm that the upper surface of top plate 30 is level and/or that opening 31 has been drilled in proper vertical alignment.

In use, the installation of, for example, a 2-inch diameter pipe would first require the user to drill a hole 31 measuring approximately 2⅛ inches into the top plate 30. The user would then insert the housing 10 of the invention into the drilled hole 31 until one of the cylindrical segments of the invention fits snugly into the hole 31. The next adjacent segment (or the stop ring 16) has a larger diameter than the hole 31. Thus, the annular shoulder of this next segment (or the stop ring 16 itself) prevents housing 10 from further insertion into hole 31. The user then activates the light source 15 which throws a spot upon the surface 40 above. If a level 18 is supplied, the user adjusts the housing 10 until it is level, and then makes one trip up the ladder to drill a hole 32 to the exterior at the location of the light spot. The user then climbs back down the ladder, removes the housing 10, shuts off the light source 15, and runs the 2 inch pipe through both holes 31 and 32.

It is to be understood that variations and modifications of the present invention may be made without departing from the scope thereof It is also to be understood that the present invention is not to be limited by the specific embodiments disclosed herein, but only in accordance with the appended claims when read in light of the foregoing specification.

What is claimed is:

1. An alignment tool for projecting a plumb line comprising:
a. a generally cylindrical housing having a proximal end and an opposite distal end comprising a plurality of cylindrical segments, each segment having a different diameter, and each segment being separated from adjacent segments by an annular shoulder;
b. a first axial opening and bore provided at the proximal end of said housing;
c. a second axial opening and bore provided at the distal end of said housing;
d. a light beam projecting source removably deployed in one of said openings.

2. The alignment tool of claim 1 wherein the diameter of each cylindrical segment corresponds approximately with a particular standard sized pipe diameter.

3. The alignment tool of claim 2 wherein one of said segments comprises a large diameter stop ring.

4. The alignment tool of claim 3 wherein said stop ring segments is located near the center of said cylindrical housing.

5. The alignment tool of claim 1 wherein a single central axial through bore is provided having openings in both the proximal and distal ends of said housing.

6. The alignment tool of claim 1 wherein said light source is integrated into said housing.

7. The alignment tool of claim 1 wherein a first light beam projecting source is integrated into said first axial opening, and a second light beam projecting source is integrated into said second axial opening.

8. The alignment tool of claim 1 wherein said light source is battery powered.

9. The alignment tool of claim 1 wherein said light source is externally powered.

10. The alignment tool of claim 1 wherein at least one level indicating device is provided on said housing.

11. A method for installing plumbing ventilation piping in an attic space comprising the steps of
a. drilling a first hole in a top plate located in the attic space;
b. placing a cylindrical spotting tool having a light beam source into the drilled hole;
c. activating said light source such that the beam emitted therefrom projects a corresponding spot upon an opposite surface;
d. drilling a second hole in said opposite surface at the location of said spot; and
e. running a pipe through the two holes.

12. An alignment tool for projecting a plumb line comprising:
a. a cylindrical housing means having a proximal end and an opposite distal end comprising a plurality of cylindrical segment means, each such segment means having a different diameter, and each segment means being separated from adjacent segments by an annular shoulder means;
b. first opening means provided at the proximal end of said housing;
c. second opening means provided at the distal end of said housing;
d. a light projecting means removably deployed in one of said openings.

13. The alignment tool of claim 12 wherein the diameter of each cylindrical segment means corresponds approximately with a particular standard sized pipe diameter.

14. The alignment tool of claim 13 wherein one of said segment means comprises a large diameter stop ring.

15. The alignment tool of claim 14 wherein said light projecting means is integrated into said housing.

16. The alignment tool of claim 15 wherein a first projecting means is integrated into said first opening, and a second light projecting means is integrated into said second opening.

17. The alignment tool of claim 13 wherein at least one level indicating device is provided on said housing.
